(19) United States
(12) Patent Application Publication
(10) Pub. No.: US 2022/0210173 A1
(43) Pub. Date: Jun. 30, 2022

(54) CONTEXTUAL ZERO TRUST NETWORK ACCESS (ZTNA) BASED ON DYNAMIC SECURITY POSTURE INSIGHTS

(71) Applicant: Fortinet, Inc., Sunnyvale, CA (US)

(72) Inventors: Roy Katmor, San Francisco, CA (US); Udi Yavo, Herzlia (IL); Ido Kelson, Tel-Aviv (IL)

(73) Assignee: Fortinet, Inc., Sunnyvale, CA (US)

(21) Appl. No.: 17/139,927

(22) Filed: Dec. 31, 2020

(51) Int. Cl. H04L 29/06

(52) U.S. Cl. CPC H04L 63/1425; H04L 63/1416; H04L 63/20; H04L 63/101; H04L 63/1433

(57) ABSTRACT

Systems and methods for enabling context-aware zero-trust network access (ZTNA) using security posture insights received from an endpoint agent are provided. According to an embodiment, of a Zero Trust Network Access (ZTNA) service module receives from an endpoint device an access request to a protected object. An identity of a user of the endpoint device is verified via an identity management system. When the identify verification is affirmative: (i) receiving from an endpoint agent running on the endpoint device, security posture information associated with one or more of the endpoint device, the user, and the protected object; (ii) determining based on a set of ZTNA policies and the security posture information whether to allow the access request; and (iii) when the determination is affirmative, granting access to the protected object by the user via the endpoint device.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2020, Fortinet, Inc.

### BACKGROUND

### Field

Embodiments of the present disclosure generally relate to Zero Trust Network Access (ZTNA). In particular, embodiments of the present disclosure relate to systems and methods for enabling context-aware ZTNA using security posture insights received from an endpoint agent (e.g., an endpoint protection platform), for example, implementing and/or supporting Endpoint Detection and Response (EDR) and/or Mobile Threat Defense (MTD) functionality.

### Description of the Related Art

Security leaders are turning to a ZTNA approach where only traffic from authenticated users, devices, and applications is granted access to other users, devices, and applications within an organization. ZTNA, also known as Software-Defined Perimeter (SDP), shifts the fundamental paradigm of open networks built around inherent trust to a zero-trust framework through the adoption of rigorous network access controls. The zero-trust philosophy goes against the traditional approach to security where users, devices, and applications were trusted to be secure simply because they were within a network perimeter.

ZTNA is an adaptive security model in which access is granted non-explicitly on a least-privileged basis defined by granular policies and driven by business needs. The ZTNA model operates on a “need to know” basis and dramatically decreases an organization's cyber risk and exposure to cyber threats.

### SUMMARY

Systems and methods are described for enabling context-aware zero-trust network access (ZTNA) using security posture insights received from an endpoint agent. According to an embodiment, of a Zero Trust Network Access (ZTNA) service module receives from an endpoint device an access request to a protected object. An identity of a user of the endpoint device is verified via an identity management system. When the identify verification is affirmative: (i) receiving from an endpoint agent running on the endpoint device, security posture information associated with one or more of the endpoint device, the user, and the protected object; (ii) determining based on a set of ZTNA policies and the security posture information whether to allow the access request; and (iii) when the determination is affirmative, granting access to the protected object by the user via the endpoint device.

Other features of embodiments of the present disclosure will be apparent from accompanying drawings and detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates an example network environment in which a zero-trust network access system may be deployed in accordance with an embodiment of the present disclosure.

FIG. 2 illustrates functional modules of a zero-trust network access system in accordance with an embodiment of the present disclosure.

FIG. 3 illustrates example ZTNA system capabilities in accordance with an embodiment of the present disclosure.

FIG. 4A illustrates an example conceptual model of an endpoint initiated ZTNA.

FIG. 4B illustrates an example conceptual model of service initiated ZTNA.

FIG. 5 illustrates an example conceptual model of service initiated ZTNA highlighting additional components in accordance with an embodiment of the present disclosure.

FIG. 6 illustrates example logical components of a ZTNA system in accordance with an embodiment of the present disclosure.

FIG. 7 illustrates an example sequence diagram enabling context-aware ZTNA using security posture insights received from an endpoint agent in accordance with an embodiment of the present disclosure.

FIG. 8 is an example flow diagram illustrating ZTNA broker processing in accordance with an embodiment of the present disclosure.

FIG. 9 illustrates an exemplary computer system in which or with which embodiments of the present disclosure may be utilized.

### DETAILED DESCRIPTION

Systems and methods are described for enabling context-aware ZTNA using security posture insights received from an endpoint agent. In the following description, numerous specific details are set forth in order to provide a thorough understanding of example embodiments. It will be apparent, however, to one skilled in the art that embodiments described herein may be practiced without some of these specific details.

ZTNA functionality can be implemented in different ways, including within a network security device (e.g., a network gateway) and in the context of secure SD-WAN and/or Secure Access Service Edge (SASE). While ZTNA has the potential to significantly lessen an organization's cyber risk and exposure to cyber threats, there remains room for improvement. For example, because ZTNA does not provide inline inspection of user traffic after the user establishes a connection to an application or host, potential security issues may arise when a user's device or credentials become compromised (or are misused by a malicious insider). Similar security issues are raised when the device, user, application, or network resource being accessed has a vulnerability or is otherwise at risk.

Embodiments of the present disclosure recognize additional insights may serve as an overlay feed in relation to ZTNA access enablement. For example, ZTNA can be forbidden or dynamically reduced when the endpoint device was under attack in the last X days, or if the respective user was associated with abnormal activity in the last X days, etc. In various embodiments, security context provided by an endpoint agent (e.g., an endpoint protection platform providing EDR and/or MTD functionality) running on an endpoint device, for example, within a predefined historical timeframe, may be used to evaluate the risk of permitting access to a requested application with reference to defined ZTNA policies. Non-limiting examples of the security context include the location of the endpoint device at issue, user posture, device posture, and application posture, which may be used individually, combined, within a predefined historical timeframe and/or weighted to verify the risk of permitting the requested access.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software operable to perform one or more security functions. Other network security devices may also include custom hardware (e.g., one or more custom Application-Specific Integrated Circuits (ASICs)). For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP, and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

As used herein, a “ZTNA service module” generally refers a component of a ZTNA architecture. Non-limiting examples of a ZTNA service module include a policy decision point (PDP) or a policy enforcement point (PEP) of the abstract model of access for Zero Trust Access described by the National Institute of Standards and Technology (NIST) in Special Publication 800-207 Natl. Inst. Stand. Technol. Spec. Publ. 800-207, 59 pages (August 2020), which is hereby incorporated by reference for all purposes. Additional, non-limiting examples of a ZTNA service module include a ZTNA controller, a ZTNA gateway, a ZTNA broker, or a ZTNA connector as described herein.

As used herein, a “ZTNA broker” or a “trust broker” generally refers to a ZTNA service module that initiates connections between users and protected objects. In various embodiments described herein, a ZTNA broker may mediate connections between private objects and authorized users based on device, user, and/or object risk metadata shared by endpoint agents (e.g., endpoint protection platforms implementing ERD and/or MTD functionality) running on respective endpoint devices being used by the users to access the applications. According to one embodiment, a ZTNA broker is implemented within a network security appliance (e.g., a UTM appliance in virtual or physical form). In other embodiments, the ZTNA broker may represent a microservice implemented in a container orchestration platform (e.g., Kubernetes, Amazon Elastic Kubernetes Service (EKS), Google Cloud Kubernetes Engine (GKE), Microsoft Azure Kubernetes Service (AKS), or the like) running in a public or private cloud.

As used herein, an identity management system generally refers to a system for identifying, authenticating, and authorizing individuals or groups of people or any subject to have access to protected objects (e.g., applications, Application Programming Interfaces (APIs), data, functions, systems or networks) by associating user/subject rights and restrictions with established identities. Non-limiting examples of an identity management system include an Identity and Access Management (IAM) tool, identity as a Service (IDaaS), Active Directory, and the like.

The phrase “endpoint protection platform” generally refers to cybersecurity monitoring and/or protection functionality implemented on an endpoint device. In one embodiment, the endpoint protection platform can be deployed in the cloud or on-premises and supports multi-tenancy. The endpoint protection platform may include a kernel-level Next Generation AntiVirus (NGAV) engine with machine learning features that prevent infection from known and unknown threats and leverage code-tracing technology to detect advanced threats such as in-memory malware. The endpoint protection platform may be deployed on the endpoint device in the form of a lightweight endpoint agent that utilizes less than one percent of CPU and less than 100 MB of RAM and may leverage, among other things, various security event classification sources provided within an associated cloud-based security service. Non-limiting examples of an endpoint protection platform include the FORTIEDR Software as a Service (SaaS) platform and the FORTICLIENT integrated endpoint protection platform available from Fortinet, Inc. of Sunnyvale, Calif.

As used herein, an “incident” generally refers to any malicious act or suspicious event observed within a private network. Such malicious acts typically (i) compromise or represent an attempt to compromise the logical border surrounding a network to which assets (e.g., programmable electronic devices and communication networks including hardware, software, and data) are connected and for which access is controlled or (ii) disrupt or represent an attempt to disrupt such assets. Non-limiting examples of types or classes of incidents include unauthorized attempts to access systems or data, privilege escalation attacks, unusual behavior from privileged user accounts, insider threats (e.g., insiders trying to access servers and data that isn't related to their jobs, logging in at abnormal times from unusual locations, or logging in from multiple locations in a short time frame), anomalies in outbound network traffic (e.g., uploading large files to personal cloud applications, downloading large files to external storage devices, or sending large numbers of email messages with attachments outside the company), traffic sent to or received from unknown locations, excessive consumption of resources (e.g., processing, memory and/or storage resources), changes in configuration (e.g., reconfiguration of services, installation of startup programs, the addition of scheduled tasks, changes to security rules or firewall changes), hidden files (may be considered suspicious due to their file names, sizes or locations and may be indicative that data or logs may have been leaked), unexpected changes (e.g., user account lockouts, password changes, or sudden changes in group memberships), abnormal browsing behavior (e.g., unexpected redirects, changes in browser configuration, or repeated pop-ups), suspicious registry entries, phishing attacks, malware attacks, denial-of-service (DoS) attacks, man-in-the-middle attacks, and password attacks.

In the context of an endpoint device, the term “event” generally refers to an action or behavior of a process running on the endpoint device. Non-limiting examples of events include filesystem events and operating system events. Events that may be initially classified as suspicious or malicious by a heuristic engine and/or a machine-learning engine employed by the endpoint protection platform, for example, may include an attempt to communication with a critical software vulnerability (CVE), an attempt to access the registry of the operating system, the network or the file system, an attempt by the process to copy itself into another process or program (in other words, a classic computer virus), an attempt to write directly to the disk of the endpoint device, an attempt remain resident in memory after the process has finished executing, an attempt to decrypt itself when run (a method often used by malware to avoid signature scanners), an attempt to binds to a TCP/IP port and listen for instructions over a network connection (this is pretty much what a bot—also sometimes called drones or zombies—do), an attempt to manipulate (copy, delete, modify, rename, replace and so forth) files that are associated with the operating system, an attempt to read the memory of sensitive programs, an attempt to hook keyboard or mouse (a/k/a keylogging), an attempt capture a screen shot, an attempt to record sounds, and/or other behaviors or actions that may be similar to processes or programs known to be malicious. In one embodiment, events may be detected or intercepted by the endpoint protection platform hooking filesystem and/or operating system application programming interface (API) calls of interest and/or by leveraging a hypervisor to monitor the operating system.

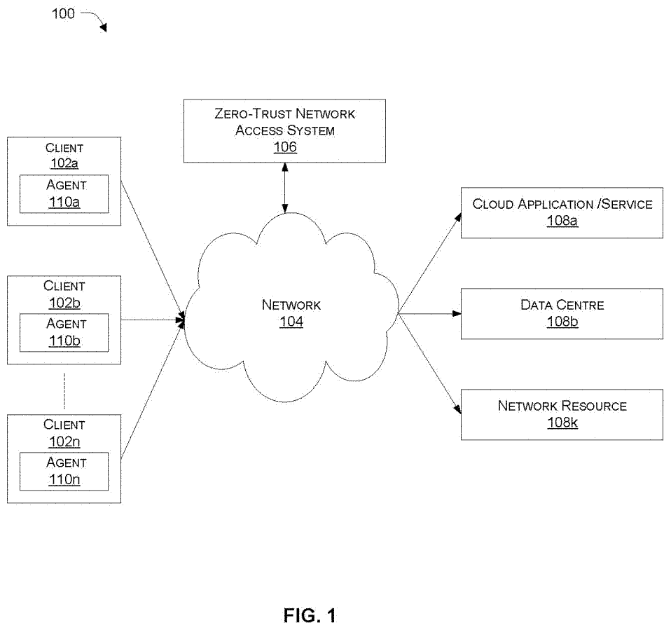

FIG. 1 illustrates an example network environment 100 in which a zero-trust network access system may be deployed in accordance with an embodiment of the present disclosure. In the context of the present example, the zero-trust network access system 106 provides context-aware ZTNA access to network resources (which may also be referred to herein interchangeably as objects), such as a cloud application or service 108a, data center 108b, or other network resources (e.g., network resource 108k) associated with a protected enterprise network connected through network 104. The object being accessed may include protected network resources, such as applications, devices, Application Program Interface (APIs), data, and functions. A subject (which may also be referred to interchangeably herein as a client) requesting access to the object may include a client device, a user, an application, and a system with their own identity. System 106 may use identity information along with security posture information to determine whether to grant access to the protected network resources 108a-k to client 102a-n. On receiving an access request from a client (e.g., client 102a, client 102b, and client 102n), the system 106 verifies the identity of the client through an identify management system or an authentication service. For example, an enterprise may use an internal enterprise directory that maintains the identity of authorized users or a third-party service. When the identity verification indicates that the client is an authorized or a trusted client, the system 206 may further determine the context in which the access request was initiated. In one embodiment, the context is derived from security posture information received from one or more of the client, the network, network devices, peer devices, and the object at issue. For example, the system 106 may collect security posture information through endpoint agents (e.g., endpoint agent 110a, endpoint agent 110b, and endpoint agent 110n) running on client devices, network devices, and protected resources. In one embodiment, the security posture information includes user security posture information, device security posture information, and application security posture information. The system 106 may determine a risk score of the access request based on the security posture information and approves the access request of the client if the risk score of the access request is less than a threshold.

In an embodiment, the ZTNA system 106 implements an identity-based schema and applies context-aware (context is derived from the security posture information) ZTNA policies to secure access to resources. System 106 may continuously collect or receive security posture information of clients 102a-n, network security devices, network security systems, protected resources, etc., and performs continuous trust evaluation. System 106 may use identity information or dynamically create an identity of the user, device, and application based on the security posture information. The system 106 may dynamically set-up least-privilege access for the client 102a-n for a given identity. System 106 may use other heuristics to determine whether the client (e.g., client 102a) actually needs access to the requested network resource (e.g., data center 108b).

Although various embodiments are explained with reference access request processing, those skilled in the art will appreciate that system 106 may perform continuous trust evaluation and thus not all ZTNA processing is responsive to receipt of an access request. Through continuous evaluation, system 106 may build trust and process access requests and can proactively isolate a user, device, or application if its security posture is indicative of suspicious activity.

As those skilled in the art will appreciate, system 106 need not be dependent upon traditional rule-based access processing or pre-granted privilege-based access processing and instead implements a context-aware zero-trust least privilege approach. System 106 may collect security posture information of the client device as well as the environment. System 106 may continually evaluate the trust level of each user, client device, client application, protected resources, and the overall environment and enforce context-aware ZTNA policies. The system 106 may intelligently decrease or increase the trust level of a connected device based on the security posture information. Various non-limiting factors that the system 106 may consider in connection with increasing or decreasing trust levels include baseline behavior of the client 102a-n, baseline behavior of other network resources, and the overall environment. Any deviation or abnormal behavior of the client 102a-n, network 104 or protected resources 108a-k identified by any security system, such as an ERD, MTD, an Intrusion Detection System (IDS), a UTM appliance or service, a DoS attack detection and/or mitigation system, an endpoint protection system/platform, an antivirus system, or the like, may represent an input collected in the form of security posture information, for system 106.

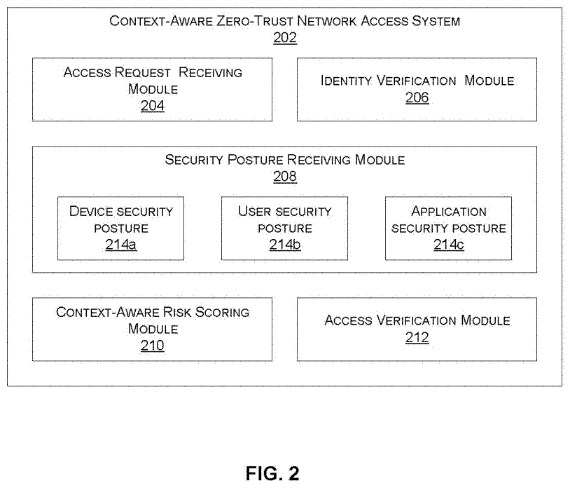

FIG. 2 illustrates functional modules of a zero-trust network access (ZTNA) system 202 in accordance with an embodiment of the present disclosure. ZTNA system 202 represents a non-limiting example of ZTNA system 106. An access request receiving module 204 integrated with a ZTNA controller (e.g., in the context of a client-initiated architecture) or a ZTNA broker (in the context of a service-initiated ZTNA architecture) of a context-aware zero-trust network access system 202 is operable to receive an access request from a client device. When the access request is received, an identity verification module 206 determines the identity of the client device, making a request to the object. Module 206 may make use of an identity management system (e.g., an enterprise directory) to determine whether the client device, in general, is authorized to access the object or not. If the client device is not authorized for accessing the requested object, module 206 may terminate the access request. If the determination of module 206 indicates that the client device, in general, is a known device and has permission to access the object, system 202 may perform further evaluation based on context-aware ZTNA policies. System 202 enables zero-trust network access, evaluates access requests responsive to a subject (user, device, application, system, etc.) attempting access to an object (which may also be referred to herein as a protected resource).

In an embodiment, system 202 includes a security posture receiving module 208 operable to receive device security posture information 214a, user security posture information 214b, and application security posture information 214c. The device security posture information 214a, user security posture information 214b, and application security posture 214c may be collectively referred to herein as security posture information. Module 208 collects security posture information from the client device initiating the request, the object being requested, and/or the overall network environment. According to one embodiment, the security posture information associated with the user is based on user behavior (e.g., user behavior anomalies) observed by the endpoint agent. Non-limiting examples of a user behavior anomaly may relate to usage of the application, a communication origin of the access request, use of a new communication protocol, use of a new port, and/or irregular working hours by the user over a particular timeframe, connections from two different remote geo-locations within a short time frame (e.g., a user connects from China right after he connected from the US or vice versa).

Similarly, the security posture information associated with the endpoint device may be based on an endpoint device behavior anomaly observed by the endpoint agent. Non-limiting examples of an endpoint device behavior anomaly include one or more of consumption of processing, storage, or memory resources of the endpoint device, installation of a new driver, or modification of a serial number of a hardware component of the endpoint device. According to one embodiment, the security posture information associated with the endpoint device is based on information that is indicative of potential attacks relating to the endpoint device or inconclusive audited incidents over a particular timeframe, software or hardware vulnerabilities of the endpoint device, or regulation or compliance issues of the endpoint device.

The security posture information receiving module 208 may receive security posture information from endpoint agents (for example, an MTD endpoint agent, an EDR endpoint agent, a NAC endpoint agent, etc.) running on each of the connected devices of the system 202. Module 208 may receive the security posture information from each connected device to enable access to the object. In an embodiment, module 208 may receive the security posture information from an Extended endpoint detection, and response platform (EDR platform) that may monitor and record observed events, incidents, and/or activities associated with endpoint devices (e.g., clients 102a-n) and other security controls. The security posture information receiving module 208 may continuously receive security posture information from endpoint agents or from the EDR platform and maintain timestamped historical information. In this manner, the context-aware ZTNA system 202 may make use of security posture information over a predetermined or configurable timeframe in connection with evaluation of access requests. The timeframe may be predefined by a network manager or can automatically be determined based on the nature of the security incident detected. By collecting security posture information of the client device, network, and the object being requested, the system 202 has information indicative of the identity of the subject (device, user and application, function, etc.), what the subject is doing, a common activity of the subject and associated risk factor or anomaly or attack if any detected in recent time. Module 208 may collect the security posture information at a level of granularity and/or retain the collected security posture information for a time period based on predefined policy or dynamically determined granularity level and time period. When a device's trust level is below a threshold, module 208 may collect granular level information from that particular device. Similarly, when an application's trust level is below a threshold, more detailed granular security posture information related to the application can be collected.

A context-aware risk scoring module 210 is operable to determine the risk score for an access request based on the security posture information collected by module 208. In an embodiment, the context-aware risk scoring module 210 may continuously evaluate the risk associated with each user, device, and application running on connected devices and that of the environment and determine the overall risk associated with a device, a user or an application, or an overall risk score of the network based on the security posture information. The risk scoring module 210 may individually determine the risk associated with each user, client device, and application instances of each client device. For example, the risk score module 210 may assign a risk score of 3 (e.g., on scale of 0-10) to a user, a risk score of 5 to a client device, and a risk score of 8 for an application. Further, module 210 may determine a cumulative risk score for an access request.

An access verification module 212 may be operable to grant access to the object for the client based on security posture information. Module 212 may use the security posture information for subjective evaluation of the access request and grant access only if the overall risk score is below a threshold. Module 212 may apply the user the risk score determined using security posture information on top of predefined rule-based processing.

The system 202 may correlate and dynamically enrich the records and classify end-devices into different risk categories and use ZTNA policy to process requests form those end-devices. The system 202 may further be operable to coordinate response to security incidents detected by different security controls and may take automated actions, including processing the access request and/or automatically isolating an endpoint device, a user or an applications from accessing critical resources. The system 202 may process access requests to an object based on the criticality level associated with the object and the determined risk score. For example, if the object is a general information portal, which is not critical or relates to low-clearance level, the system 202 may allow access even if the requesting device is of mediate risk. However, if the object being requested is a critical resource, system 202 may block access request even if the requesting device is low risk.

The system 202 may use high-fidelity security incidents, risk and vulnerability enriched data, extended user profiles, consumption and commonalities models, and other insights collected as part of security posture information as an overlay feed for ZTNA access enablement. For example, ZTNA can be forbidden or dynamically reduced if the end device was under attack in the last X days, or if the respective user was associated with abnormal activity in the last X days, etc. System 202 provides seamless access according to the needs and context derived from the security posture information. The system 202 factors in all available security posture information for ZTNA access enablement. The system 202 may use predefined rules and the dynamically determined risk score to process an access request.

The system 202 may terminate access if either the rule-based determination or the overlaying security posture based dynamically determined risk score is less than a threshold. For example, access may be allowed if a client device is accessing from an earlier seen location and if the client device has not been attacked in the last few days (e.g., last two days). If either the user is not performing the access from a previous observed location or the security posture indicates that the device was under attack in the last two days, the access request can be terminated. In an embodiment, system 202 may facilitate ZTNA adaptive access decisions using security posture information collected from endpoint threat detection and response (EDR) and mobile threat detection (MTD).

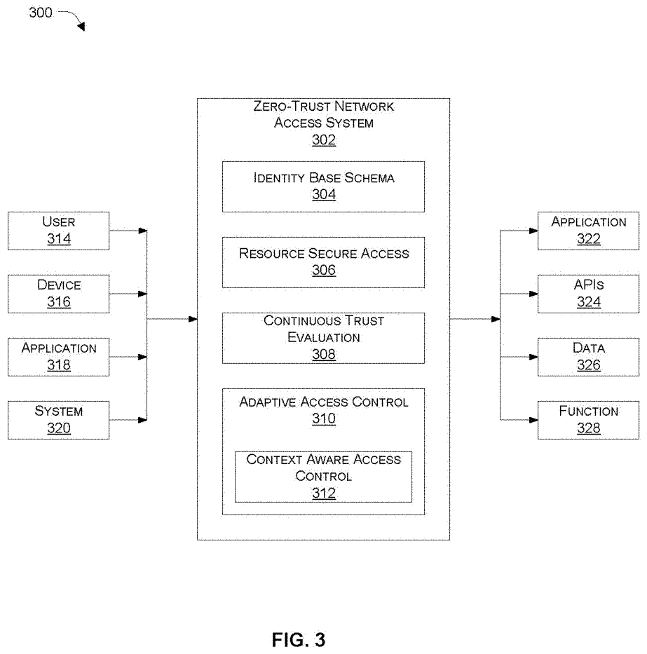

FIG. 3 illustrates example ZTNA system capabilities in accordance with an embodiment of the present disclosure. In the context of the present example, a ZTNA system 302 (representing a non-limiting example of systems 106 and 202) may implement an identity-based schema 304, provide resource security access 306, perform continuous trust evaluation 308, enable adaptive access control 310, and enable context-aware access control 312. When a subject (for example, a user 314, a device 316, an application 318, or a system 320) attempts to access an object (for example, application 322, APIs 324, Data 326, and function 328), the system 302 treats the subject by default as untrusted. The system 302 may generate the digital identity of a user, device, and application and combine the security posture information at runtime to set-up least-privileged access for the subject. System 302 provides resource security access 306 and protects all network resources. The system 302 may expose on least privilege basis only those network resources that are required and for which access is allowed after the evaluating. In ZTNA, all communication with protected network resources may be encrypted, and each connection may go through a mandatory authentication. As described above, system 302 may implement context-aware access control 312 that allows or authenticates access to protected resources after performing risk assessment based on security posture information. System 302 may be operable to perform continuous trust evaluation 308 for each of the connected devices, users, and application instances. The system 302 may start with zero trust and gradually increase the trust score of a subject based on analysis of the network data, identity information, and security posture information. In an embodiment, system 302 may perform identity-based trust evaluation and if the identity of the subject (e.g., client device) is known it may elevate trust score. The system 302 may further be operable to increase or decrease the trust level for the subject based on a risk score determined using the security posture information.

The system 302 may provide adaptive access control 310, which includes context-aware access control 312. System 302 may use a combination of Attribute-Based Access Control (ABAC), Rule-Based Access Control (RBAC), and Context-Based Access Control (CBAC). To provide access to protected network resources based on the dynamically evaluated trust level. Other access control models, such as mandatory access control (MAC), Discretionary Access Control (DAC), and other classical models and their variants can be added as a separate layer or can be applied in combination. In one embodiment, the system 302 uses security posture information and derived risk score of subjects, object, and environment to evaluate trust level and use other models in combination to process an access request. System 302 can be used for endpoint initiated ZTNA and/or service initiated ZTNA.

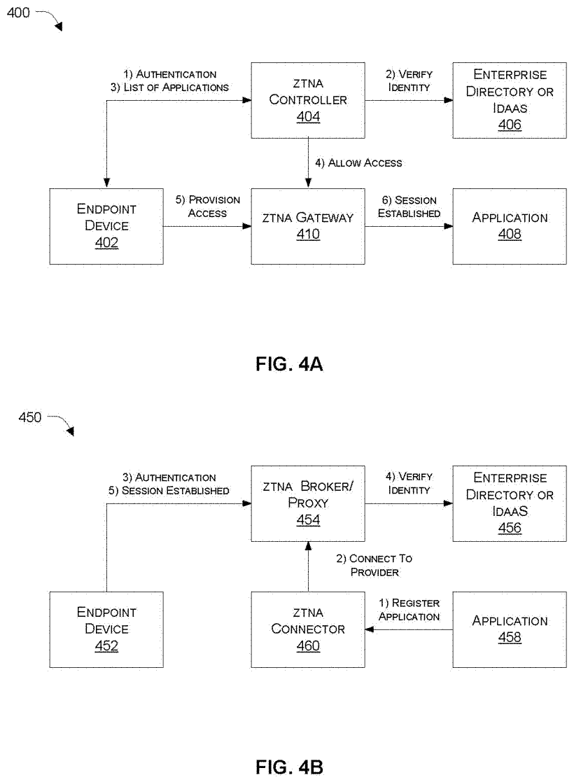

FIG. 4A illustrates an example conceptual model 400 of endpoint initiated ZTNA. In an embodiment, an agent is installed on an authorized endpoint device 402 to, among other things, send security posture information to a ZTNA service module (e.g., a ZTNA controller 404). The controller 404 may challenge the user and/or the endpoint device 402 for authentication and return a list of allowed network resources (e.g., device, application, APIs, data, etc.) once authenticated. Once the user and device are authenticated, controller 404 may provision connectivity from the endpoint device 402 through a ZTNA gateway 410 to the protected resource (e.g., application 408). The ZTNA gateway 410 shields network resources from direct internet access to protect network resources from different attacks (e.g., denial of service (DoS) attacks) and other threats they would bear if placed in a traditional demilitarized zone (DMZ). An agent installed on the authorized endpoint device 402 may initiate an authorization request, which is received at the ZTNA service module. The ZTNA service module may verify the identity of the endpoint device and/or user using an identity management service (e.g., an enterprise directory or a identity as a Service (IdaaS) module 406). The agent on endpoint device 402 may be operable to send security posture information (which may also be referred to herein as security context) to the ZTNA controller 404. The controller 404 may evaluate the risk score at runtime and adjust the trust level of the endpoint device 402 and authenticate the endpoint 402. Controller 404 provides a list of objects (network resources) that the endpoint device 402 can access and a respective list to the ZTNA gateway 410 to allow access from the authenticated device. The endpoint device 402 may select a network resource from the list of authorized network resources and obtain access through the ZTNA gateway 410. The ZTNA gateway 410 may provide access, and a secure session between the endpoint device 402 and protected network resources (e.g., application 408) can be established. The controller 404 may dynamically adjust the risk score of the device and reduce access by changing the access list set on the ZTNA gateway 410.

FIG. 4B illustrates an example conceptual model 450 of service initiated ZTNA. In the context of service initiated ZTNA, a ZTNA connector 460 may be installed in the same network in which a protected resource (e.g., application 458) establishes and maintains an outbound connection to a provider's cloud. Users or devices (e.g., endpoint device 452) authenticate through the provider to access protected network resources. A ZTNA service module (e.g., a ZTNA broker or proxy 454) may validate the user or device with an enterprise identity management product (e.g., enterprise directory or IdaaS 456). After successful validation, traffic can pass through the provider's cloud, which isolates protected network resources (e.g., application 458). The traffic may pass via the ZTNA broker/proxy 454. As those skilled in the art will appreciate, in the context of service-initiated ZTNA, firewalls do not require opening for on-bound traffic. For service initiated ZTNA, network resource (e.g., application 458) registers itself with the ZTNA controller, which may be connected to a ZTNA broker/proxy 454 of the provider. When the endpoint device 452 needs to access the protected resource (application 458), it may send an access request to the ZTNA service module running of the ZTNA broker/proxy 454. The ZTNA service module of the ZTNA broker/proxy 454 authenticates the endpoint device 452 by verifying its identity and using a risk score determined based on the security posture information. On successful authentication, a connection is established between the endpoint device 452 and application 458 through ZTNA broker/proxy 454.

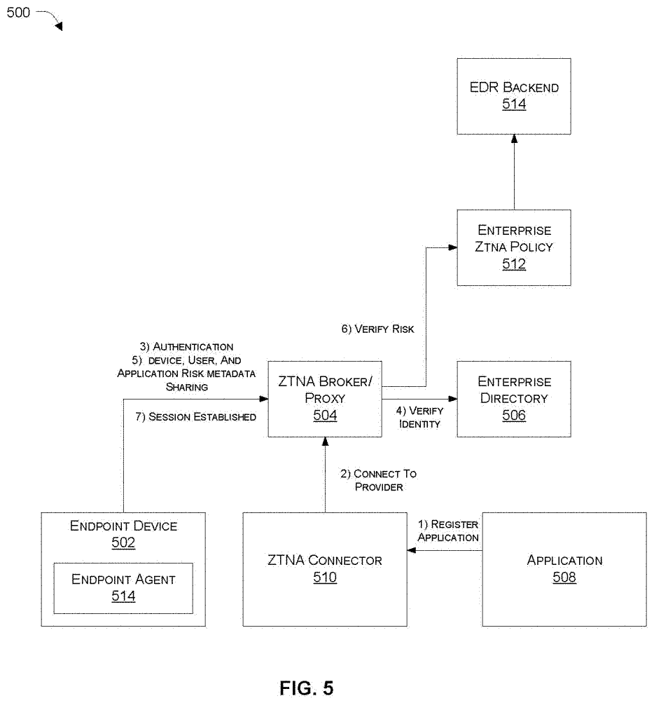

FIG. 5 illustrates an example conceptual model 500 of service initiated ZTNA highlighting additional components in accordance with an embodiment of the present disclosure. As shown in FIG. 5, a network resource (e.g., application 508) registers itself with a ZTNA controller 510, which keeps the network resources hidden. A ZTNA controller 510 connects to the provider through a ZTNA service module (e.g., a ZTNA broker/proxy 504) that performs verification of endpoint device 502 and facilitates a connection between the endpoint device 502 and application 508. When the endpoint device 502 requests access to application 508, the ZTNA service module checks whether the endpoint device is an authorized device for such a request. The ZTNA service module may block access requests when the endpoint device 502 is not an authorized device. In an embodiment, the ZTNA service module verifies the identity of the endpoint device 502 using an enterprise directory 506 and collect device, user, and application risk metadata (which may also be referred to herein as security posture information). The ZTNA service module collects the security posture information through an endpoint agent 516 installed on the endpoint device 502. The ZTNA service module verifies the risk of granting access to the application 508 using enterprise ZTNA policy 512. The ZTNA policy 512 may also make use of EDR data collected by an EDR backend 514. If the risk associated with the access request is not greater than a conservatively defined threshold, the ZTNA service module may deny the access request. In one embodiment, only when the trust level is sufficiently high (meaning risk is low), access to application 508 may be allowed. Once the access is allowed, the endpoint device 502 may establish a session with the application 508 through the ZTNA broker/proxy 504. In one embodiment, the endpoint agent (e.g., EDR agent) running on the endpoint device continues to collect all relevant data related to an event or incident detected by any security systems and continuously shares the security posture information with the EDR backend 514, which the ZTNA service module may access to evaluate the risk score.

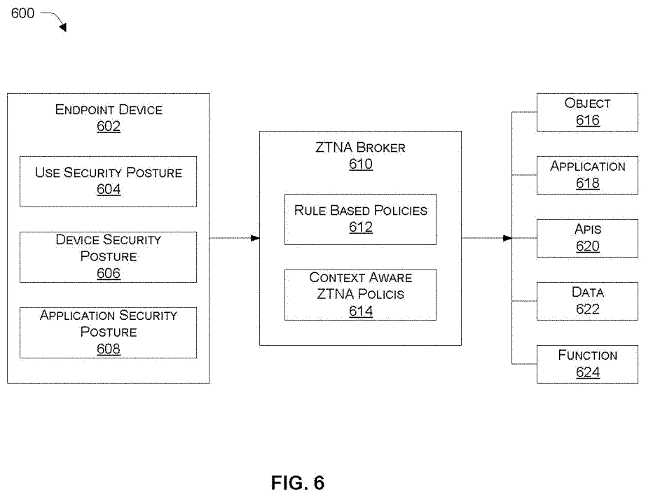

FIG. 6 illustrates example logical components of a ZTNA system 600 in accordance with an embodiment of the present disclosure. A ZTNA broker 610 (which represents a non-limiting example of ZTNA broker/proxy 504) of the ZTNA system 600 applies rules-based policy 612 as well as context-aware ZTNA policies 614 in combination to enable ZTNA. As described above, the ZTNA broker 610 may collect user security posture 604, device security posture 606, and application security posture 608 from endpoint device 602. The broker provides ZTNA to object 616, application 618, APIs 620, data 622, and function 624 on a least-privilege basis.

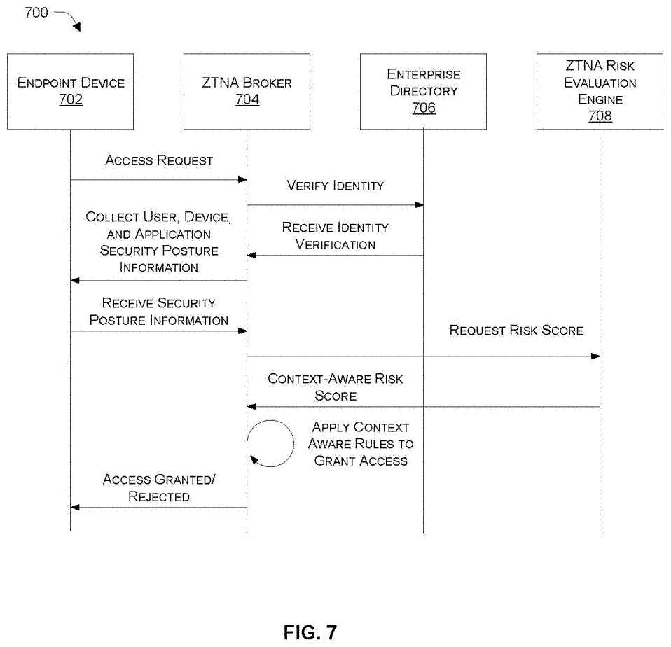

FIG. 7 illustrates an example sequence diagram 700 enabling context-aware ZTNA using security posture insights received from an endpoint agent in accordance with an embodiment of the present disclosure. As shown in FIG. 7, on receiving an access request from an endpoint device 702 for accessing a protected network resource, a ZTNA broker 704 may verify the identity of the endpoint device, and on successful identification, collect security posture information, which includes user security posture, device security posture and/or application security posture from the endpoint device 702 over a predetermined or configurable timeframe. The ZTNA broker 704 may verify the identity of the endpoint device with an enterprise directory 704. Although the sequence shows ZTNA broker 704 collecting the security posture information in response to the access request, other embodiments, the ZTNA broker may continuously collect the security posture information from the endpoint device. In some embodiments, the ZTNA broker 704 may collect some portion of the security posture information from the EDR backend server (e.g., EDR backend 514). The ZTNA broker 704 receives the security posture information and evaluates the risk of granting access to the protected resource. The ZTNA broker 704 may issue a risk evaluation request to a ZTNA policy engine 708 to evaluate the risk associated with the access request. The broker 704 may send the security posture information to the ZTNA policy engine 708. As shown in FIG. 5, the ZTNA policy engine may collect some portion of the security posture information directly from the EDR backend. The ZTNA policy engine 708 may collect the security posture information at a level of granularity required by defined ZTNA policies. The engine 708 may evaluate the risk associated with the access request based on the security posture information and context-aware ZTNA policies. The engine 708 may send context-aware risk score to the ZTNA broker 704, which process (grant/reject) the access request based on the dynamically determined context-aware risk score. The broker 704 grants access only if the risk is below a predefined threshold. Engine 708, also referred to as the risk evaluation engine, can be linked with the adaptive access control engine to provide the trust level assessment on the basis of security posture information.

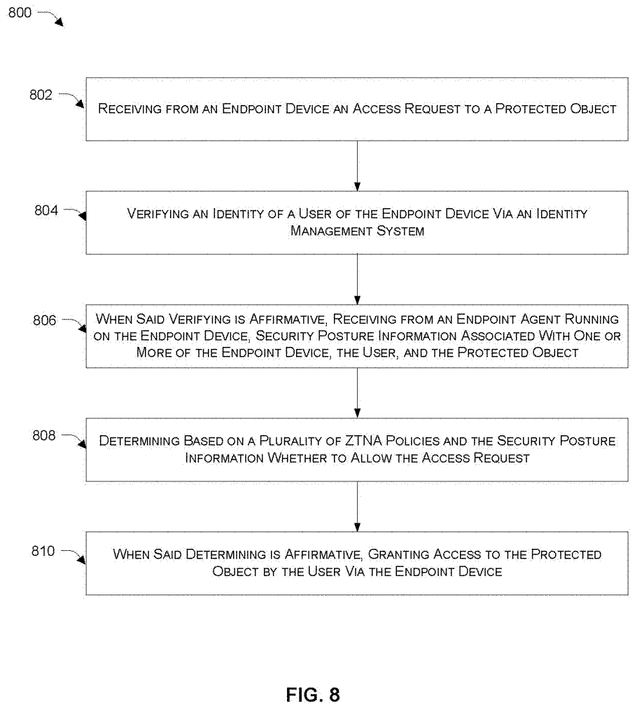

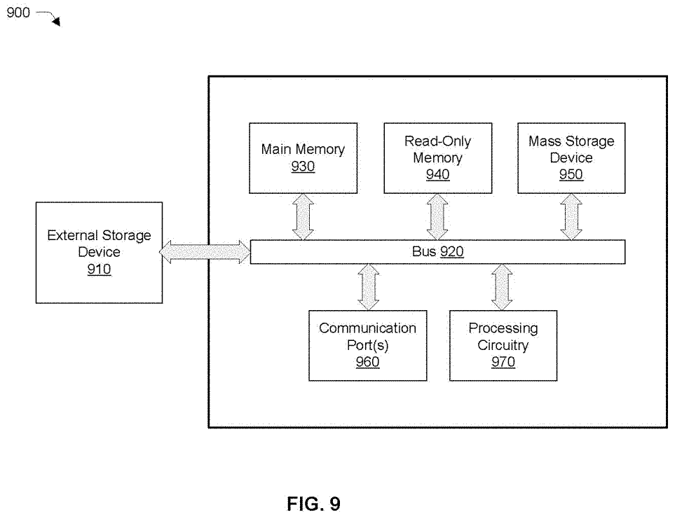

The various functional components, engines, and modules (e.g., the ZTNA broker/proxy 504, the ZTNA connector 510, the enterprise ZTNA policy 512, the enterprise directory 506, and the EDR backend 514) and other functional units described herein and the processing described below with reference to FIGS. 7-8 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer system described with reference to FIG. 9 below.

FIG. 8 is an example flow diagram illustrating ZTNA broker processing in accordance with an embodiment of the present disclosure. ZTNA broker processing 800 includes steps of receiving from an endpoint device an access request to a protected object, as shown at block 802, and verifying an identity of a user of the endpoint device via an identity management system, as shown at block 804. When said verifying is affirmative, the process performs further evaluation. Else the access request may be rejected. The process 800 further includes steps of receiving from an endpoint agent running on the endpoint device, security posture information associated with one or more of the endpoint devices, the user, and the protected object, as shown at block 806, and determining based on a plurality of ZTNA policies and the security posture information whether to allow the access request, as shown at block 808. When said determining is affirmative, the ZTNA broker grants access to the protected object by the user via the endpoint device, as shown at block 810.

FIG. 9 illustrates an exemplary computer system 900 in which or with which embodiments of the present disclosure may be utilized. As shown in FIG. 9, the computer system 900 includes an external storage device 910, a bus 920, a main memory 930, a read-only memory 940, a mass storage device 950, a communication port 960, and a processing resource (e.g., processor 970). Depending upon the particular implementation, computer system 900 may represent some portion of a ZTNA system (e.g., ZTNA system 106, 202, or 302) or a ZTNA service module (e.g., ZTNA broker/proxy 504, ZTNA broker/proxy 454, ZTNA connector 460, ZTNA gateway 410, and/or ZTNA controller 404).

Those skilled in the art will appreciate that computer system 900 may include more than one processor 970 and communication ports 960. Non-limiting examples of processing circuitry 970 include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processing circuitry 970 may include various modules associated with embodiments of the present disclosure.

Communication port 960 can be any of an RS-232 port for use with a modem-based dialup connection, a 10/100 Ethernet port, a Gigabit or 10 Gigabit port using copper or fiber, a serial port, a parallel port, or other existing or future ports. Communication port 960 may be chosen depending on a network, such as a Local Area Network (LAN), Wide Area Network (WAN), or any network to which the computer system connects.

Memory 930 can be Random Access Memory (RAM) or any other dynamic storage device commonly known in the art. Read-only memory 940 can be any static storage device(s), e.g., but not limited to, a Programmable Read-Only Memory (PROM) chips for storing static information, e.g., startup or BIOS instructions for processor 970.

Mass storage 950 may be any current or future mass storage solution, which can be used to store information or instructions or both. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB), or Firewire interfaces, or both), e.g., those available from Seagate (e.g., the Seagate Barracuda 7200 family) or Hitachi (e.g., the Hitachi Deskstar 7K900), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 920 communicatively couples processor(s) 970 with the other memory, storage, and communication blocks. Bus 920 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 970 to a software system.

Optionally, operator and administrative interfaces, e.g., a display, keyboard, and a cursor control device, may also be coupled to bus 920 to support direct operator interaction with the computer system. Other operator and administrative interfaces can be provided through network connections connected through communication port 960. An external storage device 910 can be any external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents, will be apparent to those skilled in the art without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes, various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

What is claimed is:

1. A system operable as a Zero Trust Network Access (ZTNA) service module comprising:
a processing resource;
a non-transitory computer-readable medium, coupled to the processing resource, having stored therein instructions that when executed by the processing resource cause the processing resource perform a method comprising:
receiving from an endpoint device an access request to a protected object;
verifying an identity of a user of the endpoint device via an identity management system;
when said verifying is affirmative:
receiving from an endpoint agent running on the endpoint device, security posture information associated with one or more of the endpoint device, the user, and the protected object;
determining based on a plurality of ZTNA policies and the security posture information whether to allow the access request; and
when said determining is affirmative, granting access to the protected object by the user via the endpoint device.

2. The system of claim 1, wherein the security posture information associated with the user is based on a user behavior anomaly observed by the endpoint agent.

3. The system of claim 2, wherein the protected object comprises an application and wherein the user behavior anomaly relates to one or more of usage of the application, a communication origin of the access request, use of a new communication protocol, use of a new port, irregular working hours by the user over a particular timeframe.

4. The system of claim 1, wherein the security posture information associated with the endpoint device is based on an endpoint device behavior anomaly observed by the endpoint agent.

5. The system of claim 4, wherein the endpoint device behavior anomaly relates to one or more of consumption of processing, storage, or memory resources of the endpoint device, installation of a new driver, or modification of a serial number of a hardware component of the endpoint device.

6. The system of claim 1, wherein the security posture information associated with the endpoint device is based on information indicative of (i) potential attacks relating to the endpoint device or inconclusive audited incidents over a particular timeframe, (ii) software or hardware vulnerabilities of the endpoint device, or (iii) regulation or compliance issues of the endpoint device.

7. The system of claim 1, wherein the ZTNA service module comprises a ZTNA broker and wherein the system comprises a network security appliance.

8. The system of claim 1, wherein the endpoint agent comprises an endpoint protection platform.

9. A method performed by a processing resource of a Zero Trust Network Access (ZTNA) service module, the method comprising:
receiving from an endpoint device an access request to a protected object;
verifying an identity of a user of the endpoint device via an identity management system;
when said verifying is affirmative:
receiving from an endpoint agent running on the endpoint device, security posture information associated with one or more of the endpoint device, the user, and the protected object;
determining based on a plurality of ZTNA policies and the security posture information whether to allow the access request; and
when said determining is affirmative, granting access to the protected object by the user via the endpoint device.

10. The method of claim 9, wherein the security posture information associated with the user is based on a user behavior anomaly observed by the endpoint agent.

11. The method of claim 10, wherein the protected object comprises an application and wherein the user behavior anomaly relates to one or more of usage of the application, a communication origin of the access request, use of a new communication protocol, use of a new port, irregular working hours by the user over a particular timeframe.

12. The method of claim 9, wherein the security posture information associated with the endpoint device is based on an endpoint device behavior anomaly observed by the endpoint agent.

13. The method of claim 12, wherein the endpoint device behavior anomaly relates to one or more of consumption of processing, storage, or memory resources of the endpoint device, installation of a new driver, or modification of a serial number of a hardware component of the endpoint device.

14. The method of claim 9, wherein the security posture information associated with the endpoint device is based on information indicative of (i) potential attacks relating to the endpoint device or inconclusive audited incidents over a particular timeframe, (ii) software or hardware vulnerabilities of the endpoint device, or (iii) regulation or compliance issues of the endpoint device.

15. The method of claim 9, wherein the ZTNA service module comprises a ZTNA broker operable within a network security appliance.

16. The method of claim 9, wherein the endpoint agent comprises an endpoint protection platform.

17. A non-transitory computer-readable storage medium embodying a set of instructions, which when executed by one or more processing resources of a computer system operable as a Zero Trust Network Access (ZTNA) service module, causes the one or more processing resources to perform a method comprising:
receiving from an endpoint device an access request to a protected object;
verifying an identity of a user of the endpoint device via an identity management system;
when said verifying is affirmative:
receiving from an endpoint agent running on the endpoint device, security posture information associated with one or more of the endpoint device, the user, and the protected object;
determining based on a plurality of ZTNA policies and the security posture information whether to allow the access request; and
when said determining is affirmative, granting access to the protected object by the user via the endpoint device.

18. The non-transitory computer-readable storage medium of claim 17, wherein the security posture information associated with the user is based on a user behavior anomaly observed by the endpoint agent.

19. The non-transitory computer-readable storage medium of claim 18, wherein the protected object comprises an application and wherein the user behavior anomaly relates to one or more of usage of the application, a communication origin of the access request, use of a new communication protocol, use of a new port, irregular working hours by the user over a particular timeframe.

20. The non-transitory computer-readable storage medium of claim 17, wherein the security posture information associated with the endpoint device is based on an endpoint device behavior anomaly observed by the endpoint agent and wherein the endpoint device behavior anomaly relates to one or more of consumption of processing, storage, or memory resources of the endpoint device, installation of a new driver, or modification of a serial number of a hardware component of the endpoint device.
